(19) United States
(12) Patent Application Publication
(10) Pub. No.: US 2026/0128364 A1
(43) Pub. Date: May 7, 2026

(54) ALL-SOLID-STATE BATTERY INCLUDING DOUBLE LAYER SOLID ELECTROLYTE AND METHOD FOR MANUFACTURING THE SAME

(71) Applicants: HYUNDAI MOTOR COMPANY, Seoul (KR); Kia Corporation, Seoul (KR)

(72) Inventors: Min Sun Kim, Hwaseong-si (KR); Yeo Min Yoon, Hwaseong-si (KR); Yong Seok Choi, Hwaseong-si (KR); Young Jin Nam, Hwaseong-si (KR)

(73) Assignees: HYUNDAI MOTOR COMPANY, Seoul (KR); Kia Corporation, Seoul (KR)

(21) Appl. No.: 19/195,584

(22) Filed: Apr. 30, 2025

(30) Foreign Application Priority Data
Nov. 4, 2024 (KR) 10-2024-0154681

(51) Int. Cl. H01M 10/0562

(52) U.S. Cl. CPC H01M 10/0562; H01M 2300/0068

(57) ABSTRACT

Provided are an all-solid-state battery including a double layer solid electrolyte, which improves the robustness while suppressing a thermal runway phenomenon and exhibits an excellent electro-chemical characteristic, and a method for manufacturing the same. The all-solid-state battery includes a negative electrode, a first solid electrolyte layer positioned on the negative electrode, a second solid electrolyte layer disposed on the first solid electrolyte layer, and a positive electrode positioned on the second solid electrolyte layer. The first solid electrolyte layer includes an inorganic flame retardant, and the second solid electrolyte layer includes an endothermic flame retardant.

### CROSS-REFERENCE TO RELATED APPLICATION

This application claims the benefit of priority to Korean Patent Application No. 10-2024-0154681, filed in the Korean Intellectual Property Office on Nov. 4, 2024, the entire contents of which are incorporated herein by reference.

### TECHNICAL FIELD

The present disclosure relates to an all-solid-state battery including a double layer solid electrolyte, capable of improving the robustness of an electrolyte layer while suppressing a thermal runway phenomenon and a method for manufacturing the same.

### BACKGROUND

A lithium secondary battery has been extensively used in various fields such as an electric vehicle and a portable electronic device, but causes several safety issues. In particular, a positive electrode material having a higher content of nickel (Ni) has been mainly employed for the purpose of a higher energy density, which results in reducing the starting temperature of pyrolysis to increase calorific value, such that the risk of a thermal runway phenomenon is increased. In addition, a silicon (Si) negative electrode has been employed for the purpose of a higher theoretical capacity. The silicon negative electrode is severely expanded the in volume during charging/discharging process and causes the precipitation of lithium metal during the charging/discharging process for a longer term, which results in an internal short circuit of a battery such that the thermal runway phenomenon is caused.

Accordingly, an all-solid-state battery has been significantly spotlighted as a next-generation energy storage device because of reducing the leakage of an electrolyte or the risk of flame by using a solid electrolyte, which is different from an existing lithium ion battery. However, the all-solid-state battery is not free in a safety issue such as the thermal runway phenomenon. In particular, the all-solid-state battery has a difficulty in maintaining both thermal stability and mechanical stability between the positive electrode and the negative electrode due to the characteristic of a multi-layer structure. Accordingly, there is required the development of the all-solid-state battery capable of maintaining the energy density and the performance while ensuring both the thermal stability and the mechanical stability.

### SUMMARY

The present disclosure has been made to solve the above-mentioned problems occurring in the prior art while advantages achieved by the prior art are maintained intact.

An aspect of the present disclosure relates to an all-solid-state battery including a double layer solid electrolyte, capable of improving the robustness of an electrolyte layer while suppressing a thermal runway phenomenon and a method for manufacturing the same.

More specifically, the present disclosure is to improve the robustness of an electrolyte layer through a first solid electrolyte layer including an inorganic flame retardant, and to reduce a heating start temperature through a second solid electrolyte layer including an endothermic flame retardant such that a thermal runway phenomenon is suppressed.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, there is provided an all-solid-state battery including a double layer solid electrolyte and a method for manufacturing the same.

In more detail, (1) the present disclosure provides an all-solid-state battery including a negative electrode, a first solid electrolyte layer positioned on the negative electrode, a second solid electrolyte layer positioned on the first solid electrolyte layer, and a positive electrode positioned on the second solid electrolyte layer. The first solid electrolyte layer includes an inorganic flame retardant, and the second solid electrolyte layer includes an endothermic flame retardant.

(2) The present disclosure provides an all-solid-state battery, in which the inorganic flame retardant includes at least one selected from the group consisting of LLZO, LATP, SiO₂, ZnO, SnO₂, Mn₃O₄, Sn₂P₂O₇, an aluminum oxide, a magnesium oxide, zeolite, a zirconium compound, a calcium salt, and a boron compound, in (1).

(3) The present disclosure provides an all-solid-state battery, in which the first solid electrolyte layer includes the inorganic flame retardant in an amount ranging from 20 wt % to 50 wt %, based on a weight of a solid electrolyte included in the first solid electrolyte layer, in (1) or (2).

(4) The present disclosure provides an all-solid-state battery, in which the endothermic flame retardant includes at least one selected from the group consisting of Mg(OH)₂, Al(OH)₃, Sb₂O₃, H₃BO₃, Fe(OH)₃, CaCO₃, Ca(OH)₂, Zn(OH)₂, NaOH, a calcium-magnesium hydroxide, hydrotalcite, bemate, talc, doconite, calcium sulfate hydrate, and magnesium sulfate hydrate, in any one of (1) to (3).

(5) The present disclosure provides an all-solid-state battery, in which the second solid electrolyte layer includes the endothermic flame retardant in an amount ranging from 5 wt % to 20 wt %, based on a weight of a solid electrolyte included in the second solid electrolyte layer, in any one of (1) to (4).

(6) The present disclosure provides an all-solid-state battery, in which a ratio between a thickness of the first solid electrolyte layer and a thickness of the second solid electrolyte layer ranges from 1:9 to 9:1, in any one of (1) to (5).

(7) The present disclosure provides an all-solid-state battery, in which a sum of a thickness of the first solid electrolyte layer and a thickness of the second solid electrolyte layer ranges from 10 μm to 120 μm, in any one of (1) to (6).

(8) The present disclosure provides an all-solid-state battery, in which each of the first solid electrolyte layer and the second solid electrolyte layer further includes a binder, in any one of (1) to (7).

(9) The present disclosure provides an all-solid-state battery, in which the content of the binder ranges from 0.5 wt % to 5 wt %, based on a weight of a solid electrolyte in each of the first solid electrolyte layer and the second solid electrolyte layer, in (8).

(10) The present disclosure provides an all-solid-state battery, in which the binder includes at least one selected from the group consisting of polybutadiene rubber (BR), styrene-butadiene rubber (SBR), nitrile butadiene rubber (NBR), polyimide (PI), polyvinylidene fluoride (PVDF), and ethylene propylene diene monomer rubber (EPDM), in (8) or (9).

(11) The present disclosure provides a method for manufacturing an all-solid-state battery, which includes manufacturing the all-solid-state battery in which a negative electrode, a first solid electrolyte layer, a second solid electrolyte layer, and a positive electrode are sequentially stacked (S0), in which the first solid electrolyte layer includes an inorganic flame retardant, and the second solid electrolyte layer includes an endothermic flame retardant.

(12) The present disclosure provides a method for manufacturing an all-solid-state battery, in which the manufacturing the all-solid-state battery includes manufacturing a negative electrode assembly by sequentially stacking the negative electrode, the first solid electrolyte layer, and the second solid electrolyte layer, and stacking the negative electrode assembly and the positive electrode such that the second solid electrolyte layer faces the positive electrode, in (11).

(13) The present disclosure provides a method for manufacturing an all-solid-state battery, in which the negative electrode assembly is manufactured in a wet-on-wet or wet-on-dry scheme, in (12).

(14) The present disclosure provides a method for manufacturing an all-solid-state battery, in which a manufacturing the all-solid-state battery includes manufacturing a positive electrode assembly by sequentially stacking the positive electrode, the second solid electrolyte layer, and the first solid electrolyte layer, and stacking the positive electrode assembly and the negative electrode such that the first solid electrolyte layer faces the negative electrode, in (11).

(15) The present disclosure provides a method for manufacturing an all-solid-state battery, in which the positive electrode assembly is manufactured in a wet-on-wet or wet-on-dry scheme, in (14).

(16) The present disclosure provides a method for manufacturing an all-solid-state battery, in which the manufacturing the all-solid-state battery includes manufacturing a negative electrode assembly including the negative electrode and the first solid electrolyte layer, manufacturing a positive electrode assembly including the positive electrode and the second solid electrolyte layer, and stacking the positive electrode assembly and the positive electrode assembly such that the first solid electrolyte layer and the second solid electrolyte layer face each other, in (11).

(17) The present disclosure provides a method for manufacturing an all-solid-state battery, in which wherein each of the negative electrode assembly or the positive electrode assembly is manufactured in a wet-on-wet or wet-on-dry scheme, in (16).

(18) The present disclosure provides an all-solid-state battery, which includes negative electrode; a first solid electrolyte layer positioned on the negative electrode; a second solid electrolyte layer disposed on the first solid electrolyte layer; and a positive electrode positioned on the second solid electrolyte layer, wherein the first solid electrolyte layer includes at least one component selected from the group consisting of LLZO, LATP, SiO₂, ZnO, SnO₂, Mn₃O₄, Sn₂P₂O₇, an aluminum oxide, a magnesium oxide, zeolite, a zirconium compound, a calcium salt, and a boron compound, and wherein the second solid electrolyte layer includes at least one component selected from the group consisting of Mg(OH)₂, Al(OH)₃, Sb₂O₃, H₃BO₃, Fe(OH)₃, CaCO₃, Ca(OH)₂, Zn(OH)₂, NaOH, a calcium-magnesium hydroxide, hydrotalcite, bemate, talc, doconite, calcium sulfate hydrate, and magnesium sulfate hydrate.

(19) The present disclosure provides an all-solid-state battery, in which the at least one component included in the first solid electrolyte layer is in an amount ranging from 20 wt % to 50 wt %, based on a weight of a solid electrolyte included in the first solid electrolyte layer, in (18).

(20) The present disclosure provides an all-solid-state battery, in which the at least one component included in the second solid electrolyte layer is in an amount ranging from 5 wt % to 20 wt %, based on a weight of a solid electrolyte included in the second solid electrolyte layer, in (18)

### BRIEF DESCRIPTION OF THE DRAWINGS

The above and other objects, features and advantages of the present disclosure will be more apparent from the following detailed description taken in conjunction with the accompanying drawings:

FIG. 1 is a graph illustrating differential scanning calorimetry (DSC) results of an all-solid-state battery according to embodiments and a comparative example according to the present disclosure;

FIG. 2 is a graph illustrating the robustness characteristic of an all-solid-state battery, which is measured by Saicas equipment, according to embodiments of the present disclosure and a comparative example;

FIG. 3A is a graph illustrating a charging/discharging characteristic of an all-solid-state battery, according to embodiments of the present disclosure and a comparative example;

FIG. 3B is a graph illustrating a capacity retention rate (%) of an all-solid-state battery depending on a cycle repeated, according to an embodiment of the present disclosure and a comparative example;

FIG. 4A is a view illustrating a cross-section of an all-solid-state battery after impact through CT analysis, according to an embodiment of the present disclosure, and FIG. 4B is a view illustrating a cross-sections of an all-solid-state battery after impact through CT analysis, according to a comparative example; and

FIG. 5 is a cross-sectional view schematically illustrating an all-solid-state battery according to an embodiment of the present disclosure.

### DETAILED DESCRIPTION

Hereinafter, the present disclosure will be described in more detail.

Terms or words used in the present specification and the claims should not be interpreted as commonly-used dictionary meanings, but be interpreted as to be relevant to the technical scope of the present disclosure based on the fact that the inventor may properly define the concept of the terms to explain the present disclosure in best ways.

### All-Solid-State Battery

The present disclosure provides an all-solid-state battery including a negative electrode, a first solid electrolyte layer positioned on the negative electrode, a second solid electrolyte layer positioned on the first solid electrolyte layer, and a positive electrode positioned on the second solid electrolyte layer. The first solid electrolyte layer includes an inorganic flame retardant, and the second solid electrolyte layer includes an endothermic flame retardant.

Hereinafter, components of the all-solid-state battery according to the present disclosure will be described in detail.

### Negative Electrode

According to the present disclosure, the negative electrode may have the form in which an negative electrode active material layer is coated on a negative electrode current collector.

The negative electrode current collector, which collects a current such that electrons move to an external circuit of the all-solid-state battery, may provide a higher electrical conductivity such that the electrons rapidly move. The type of the negative electrode current collector includes various materials without limitation, as long as the materials have conductivity without causing the chemical change of the all-solid-state battery. For example, the material may preferably include at least one selected from the group consisting of copper, stainless steel, aluminum, nickel, titanium, sintered carbon, a material obtained by performing surface-treatment for the surface of copper or stainless steel with carbon, nickel, titanium, or silver, and an aluminum-cadmium alloy.

The negative electrode active material layer may include a negative electrode active material, a binder for fixing the negative electrode active material, a conductive material for improving the conductivity of electrons, and a solid electrolyte.

The negative electrode active material may include various materials without limitation, as long as the materials are applicable to the negative electrode. Preferably, the negative electrode active material may include, preferably, at least one selected from the group consisting of lithium metal, graphite, silicon, a lithium titanium oxide (LTO), graphite, and carbon-nano tube (CNT). More preferably, the negative electrode active material may include silicon and graphite.

The binder may include various materials without specific limitation, as long as the various materials fix materials of the negative electrode active material layer. Preferably, the binder may include at least one selected from the group consisting of polybutadiene rubber, polyimide, ethylene propylene diene monomer, polytetrafluoroethylene, polyethylene oxide, polyethyleneglycol, polyacrylonitrile, polyvinylchloride, polymethylmethacrylate, polypropyleneoxide, polyphosphazene, polysiloxane, polydimethylsiloxane, polyvinylidenefluoride, polyvinylidene fluoride-hexafluoropropylene copolymer (PVDF-HFP), polyvinylidene fluoride-chlorotrifluoroethylene copolymer (PVDF-CTFE), polyvinylidene fluoride-tetrafluoroethylene copolymer (PVDF-TFE), polyvinylidenecarbonate, polyvinylpyrrolidinone, styrene-butadiene rubber, nitrile-butadiene rubber, and hydrogenated nitrile butadiene rubber. More particularly, the binder may include polybutadiene rubber.

The conductive material, which is able to be contained in the negative electrode active material layer, may include various conductive materials without specific limitation, as long as the conductive materials improve the electrical conductivity of the negative electrode active material layer without causing the chemical change. For example, the conductive material may, preferably, include at least one selected from the group consisting of carbon-based material, such as natural graphite, artificial graphite, carbon black, acetylene black, ketjen black, carbon fiber, and a carbon nano-tube, a metal-based material in the form of metal powders or metal fibers containing copper, nickel, aluminum, or silver, and a conductive polymer such as polyphenylene derivatives.

The solid electrolyte may be an inorganic solid electrolyte, such as a sulfide-based solid electrolyte, an oxide-based solid electrolyte, or a halide-based solid electrolyte, or a solid polymer electrolyte.

The sulfide-based solid electrolyte may be various general sulfide-based solid electrolytes without being specifically limited. Preferably, the sulfide-based solid electrolyte may include at least one selected from the group consisting of Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂SSiS₂—LiI, Li₂S—SiS₂—LiBr, Li₂S—SiS₂—LiCl, Li₂S—SiS₂—B₂S₃—LiI, Li2ₛ—SiS₂—P₂S₅—LiI, Li₂S—B₂S₃, Li₂S—P₂S₅—ZₘSₙ (in which ‘m’ and ‘n’ is positive numbers; Z is one of Ge, Zn, and Ga), Li₂S—GeS₂, Li₂S—SiS₂—Li₃PO₄, Li₂S—SiS₂-LiₓMO_{y} (in which ‘x’ and ‘y’ are positive numbers; M is one among P, Si, Ge, B, Al, Ga, and In), and Li₁₀GeP₂S₁₂.

The oxide-based solid electrolyte may be various general oxide-based solid electrolytes without being specifically limited. Preferably, the oxide-based solid electrolyte may include at least one selected from the group consisting of Li_{1+x+y}AlₓTi₂₋ₓSi_{y}P_{3-y}O₁₂ (0<x<2, 0≤y<3), BaTiO₃, Pb(Zr,Ti)O₃(PZT), Pb₁₋ₓLaₓZr_{1-y}Ti_{y}O₃(PLZT) (0≤x<1, 0≤y<1), PB(Mg₃Nb_{2/3})O₃—PbTiO₃(PMN-PT), HfO₂, SrTiO₃, SnO₂, CeO₂, Na₂O, MgO, Nio, Cao, Bao, ZnO, ZrO₂, Y₂O₃, Al₂O₃, TiO₂, SiO₂, Li₃PO₄, LiₓTi_{y}(PO₄)₃(0<x<2, 0<y<3), LiₓAl_{y}Ti_{z}(PO₄)₃ (0<x<2, 0<y<1, 0<z<3), Li_{1+x+y}(Al,Ga)ₓ(Ti,Ge)₂₋ₓSi_{y}P_{3-y}O₁₂(0≤x≤1 and 0≤y≤1), LiₓLa_{y}TiO₃ (0<x<2 and 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (M=Te, Nb, or Zr; 0≤x≤10) and Li₇La₃Zr₂₋ₓTaₓO₁₂ (0<x<2; LLZ-Ta).

The solid polymer electrolyte may be various general solid polymer electrodes without being specifically limited. Preferably, the solid polymer electrolyte may include at least one selected from the group consisting of polyethylene oxide, poly(diallyldimethylammonium)TFSI), Cu₃N, Li₃N, LiPON, Li₃PO₄·Li₂S·SiS₂, Li₂S·GeS₂·Ga₂S₃, Li₂O·11Al₂O₃, Na₂O·11Al₂O₃, (Na,Li)₁₊ₓTi₂₋ₓAlₓ(PO₄)₃(0.1≤x≤0.9), Li₁₊ₓHf₂₋ₓAlₓ(PO₄)₃(0.1≤x≤0.9), Na₃Zr₂Si₂PO₁₂, Li₃Zr₂Si₂PO₁₂, Na₅ZrP₃O₁₂, Na₅TiP₃O₁₂, Na₃Fe₂P₃O₁₂, Na₄NbP₃O₁₂, Na-Silicates, Li_{0.3}La_{0.5}TiO₃, Na₅MSi₄O₁₂ (M′ is a rare-each element such as Nd, Gd, or Dy) Li₅ZrP₃O₁₂, Li₅TiP₃O₁₂, Li₃Fe₂P₃O₁₂, Li₄NbP₃O₁₂, Li₁₊ₓ(M,Al,Ga)ₓ(Ge_{1-y}Ti_{y})₂₋ₓ(PO₄)₃(x≤0.8; 0≤y≤1.0; M is Nd, Sm, Eu, Gd, Tb, Dy, Ho, Er, Tm or Yb), Li_{1+x+y}QₓTi₂₋ₓSi_{y}P_{3-y}O₁₂ (0<x≤0.4; 0<y≤0.6; Q is Al or Ga), Li₆BaLa₂Ta₂O₁₂, Li₇La₃Zr₂O₁₂, Li₅La₃Nb₂O₁₂, Li₅La₃M₂O₁₂ (M is Nb or Ta) and Li₇₊ₓAₓLa₃₋ₓZr₂O₁₂ (0<x<3; A is Zn).

The halide-based solid electrolyte may include a Li element, an M element (‘M’ is metal other than Li), and an X element (‘X’ is halogen). In this case, ‘X’ may be, for example, in the halide-based solid F, Cl, Br, and I. Especially, electrolyte, the ‘X’ is preferably at least one of Br and Cl. In addition, the M may be, for example, a metal element, such as Sc, Y, B, Al, Ga, and In.

### First Solid Electrolyte Layer

According to the present disclosure, the first solid electrolyte layer includes a solid electrolyte and an inorganic flame retardant having the higher particle strength to maintain the robustness even if the negative electrode is greatly expanded in volume and precipitates the lithium metal. In this case, the solid electrolyte may be applied like a solid electrolyte contained in the negative electrode.

The inorganic flame retardant may include various materials without specific limitation, as long as the various materials are materials having a flame retarding property based on an inorganic material having a higher particle strength and applying thermal stability to the all-solid-state battery. For example, the inorganic flame retardant may preferably include at least one selected from the group consisting of LLZO, LATP, SiO₂, ZnO, SnO₂, Mn₃O₄, Sn₂P₂O₇, an aluminum oxide, a magnesium oxide, zeolite, a zirconium compound, a calcium salt, and a boron compound. More preferably, the inorganic flame retardant may include LATP.

The inorganic flame retardant may be included in content ranging from 20 wt % to 50 wt %, and more preferably, in content ranging from 25 wt % or 30 wt % to 45 wt % or 40 wt %, based on the solid electrolyte included in the first solid electrolyte layer. When the inorganic flame retardant is included in content having the above range, the inorganic flame retardant may improve the thermal stability of the first solid electrolyte layer, reduce the risk of the thermal runway phenomenon of the all-solid-state battery, and improve the mechanical characteristic of the all-solid-state battery without degrading the electrical performance such as an ion conductivity or voltage characteristic.

The first solid electrolyte layer according to the present disclosure may further include a binder. When the first solid electrolyte layer further includes the binder, the mechanical strength and the durability of the first solid electrolyte layer may be improved, and the whole performance and the whole lifespan of the all-solid-state battery may be increased. In this case, the binder may be applied like a binder which is able to be contained in the negative electrode.

The binder may be included in content ranging from 0.5 wt % to 5 wt %, and more preferably, in content ranging from 2 wt % to 4 wt %, based on the solid electrolyte included in the first solid electrolyte layer. When the binder is included in content having the above range, the binding between particles of the solid electrolyte may be strengthened to optimize the mechanical strength and the structural stability of the first solid electrolyte layer, such that the durability of the all-solid-state battery is increased. In addition, the binder may provide the structural stability without interrupting the ion conductivity path. Accordingly, the binder may maintain the electro-chemical performance of the all-solid-state battery while increasing the charging/discharging efficiency of the all-solid-state battery.

### Second Solid Electrolyte Layer

The second solid electrolyte layer according to the present disclosure may include a solid electrolyte and the endothermic flame retardant to prevent heat, which is emitted from the positive electrode, from being transferred to the whole cell, as the heat is absorbed into the endothermic flame retardant first, thereby suppressing the thermal runway phenomenon of the all-solid-state battery. In this case, the solid electrolyte may be applied like the solid electrolyte which is able to be contained in the negative electrode.

The endothermic flame retardant may include various materials without a specific limitation, as long as the materials are employed as common endothermic flame retardant. Preferably, the endothermic flame retardant may include at least one selected from the group consisting of Mg(OH)₂, Al(OH)₃, Sb₂O₃, H₃BO₃, Fe(OH)₃, CaCO₃, Ca(OH)₂, Zn(OH)₂, NaOH, a calcium-magnesium hydroxide, hydrotalcite, bemate, talc, doconite, calcium sulfate hydrate, and magnesium sulfate hydrate. More preferably, the endothermic flame retardant may include Al(OH)₃. In addition, the halogen-based flame retardant may be applied to the present disclosure, as the halogen-based flame retardant is included in the reaction mechanism.

The endothermic flame retardant may be included in content ranging from 5 wt % to 20 wt %, and more preferably, in content ranging from 7 wt % to 15 wt %, based on the solid electrolyte included in the second solid electrolyte layer. When the endothermic flame retardant is included in content having the above range, the endothermic flame retardant may improve the thermal stability of the second solid electrolyte layer, reduce the risk of the thermal runway phenomenon of the all-solid-state battery, and improve the mechanical characteristic of the all-solid-state battery without degrading the electrical performance such as an ion conductivity or a voltage characteristic.

The second solid electrolyte layer according to the present disclosure may further include a binder. When the second solid electrolyte layer further includes the binder, the mechanical strength and the durability of the second solid electrolyte layer may be improved, and the whole performance and the whole lifespan of the all-solid-state battery may be increased. The binder may be applied like the binder, which is able to be contained in the negative electrode, and the binder which is able to be contained in the first solid electrolyte layer.

According to the present disclosure, the ratio between the thickness of the first solid electrolyte layer and the thickness of the second solid electrolyte layer may range from 1:9 to 9:1. Preferably, the ratio between the thickness of the first solid electrolyte layer and the thickness of the second solid electrolyte layer may range from 2:8 to 8:2 or 3:7 to 7:3. When the ratio satisfies the relevant range, the onset temperature of exothermic reaction may decrease, leading to a reduction in the amount of heat generated. Accordingly, the thermal stability of the all-solid-state battery may be more increased. In addition, the durability of the electrolyte layer may be increased.

The sum of thicknesses of the first solid electrolyte layer and the second solid electrolyte layer may range from 10 μm to 120 μm, and preferably range from 30 μm to 80 μm. As the sum of the thicknesses satisfies the relevant range, the ion conductivity may be optimized to maintain the electro-chemical performance of the all-solid-state battery while uniformly maintaining the charging/discharging speed or the energy density. In addition, the resistance against the impact or the deformation may be maintained while the durability of the battery may be ensured for the longer term. In addition, the higher energy density may be ensured, and the contact area with the electrode may be optimized to maximize the performance of the all-solid-state battery.

### Positive Electrode

The positive electrode according to the present disclosure may have the form in which a positive electrode active material layer is coated on a positive electrode current collector, and the positive electrode active material layer may include a positive electrode active material, a binder, a conductive material, and a solid electrolyte. The binder, the conductive material, and the solid electrolyte may be applied like the binder, the conductive material, and the solid electrolyte which are able to be contained in the negative electrode.

The positive electrode active material may include various materials without specific limitation, as long as the various materials are active materials employed for the positive electrode. For example, the positive electrode may preferably include at least one selected from the group consisting of a lithium cobalt oxide (LCO), a lithium manganese oxide (LMO), a lithium iron phosphate (LFP), a nickel cobalt manganese oxide (NCM), a nickel cobalt aluminum oxide (NCA), and a lithium nickel manganese oxide (LNMO). More preferably, the positive electrode active material may include a lithium cobalt manganese oxide.

Method for Manufacturing Negative Electrode for all-Solid-State Battery

The present disclosure provides a method (or a manufacturing method) for manufacturing an all-solid-state battery, which includes manufacturing the all-solid-state battery having a structure in which the negative electrode, the first solid electrolyte layer, the second solid electrolyte layer, and the positive electrode are sequentially stacked (S0). The first solid electrolyte layer includes the inorganic flame retardant, and the second solid electrolyte layer includes the endothermic flame retardant.

Hereinafter, the manufacturing method of the present disclosure will be described in detail step by step.

‘S0’ may include the steps for manufacturing a negative electrode assembly formed by sequentially stacking the negative electrode, the first solid electrolyte layer, and the second solid electrolyte layer (S1) and stacking the negative electrode assembly and the positive electrode such that the second solid electrolyte layer faces the positive electrode. The negative electrode assembly may be manufactured in a wet-on-wet scheme or a wet-on-dry scheme.

When the negative electrode assembly is manufactured in the wet-on-wet scheme, ‘S0’ may include the step for coating a negative electrode slurry on the negative electrode current collector, and sequentially coating and drying a first solid electrolyte slurry and a second solid electrolyte slurry, in the state that the negative electrode slurry coated on the negative electrode current collector is not dried.

When the negative electrode assembly is manufactured in the wet-on-dry scheme, ‘S0’ may include the step for forming the negative electrode by coating and drying the negative electrode slurry on the negative electrode current collector, forming the first solid electrolyte layer by coating and drying the first solid electrolyte slurry on the negative electrode, and coating and drying the second solid electrolyte slurry on the first solid electrolyte layer.

In addition, ‘S0’ may include the steps for manufacturing a positive electrode assembly formed by sequentially stacking the positive electrode, the second solid electrolyte layer, and the first solid electrolyte layer (S1′) and stacking the positive electrode assembly and the negative electrode such that the first solid electrolyte layer faces the negative electrode. The positive electrode assembly may be manufactured in a wet-on-wet scheme or a wet-on-dry scheme.

When the positive electrode assembly is manufactured in the wet-on-wet scheme, ‘S0’ may include the step for coating a positive electrode slurry on the positive electrode current collector, and sequentially coating and drying the second solid electrolyte slurry and the first solid electrolyte slurry, in the state that the positive electrode slurry coated on the positive electrode current collector is not dried.

When the positive electrode assembly is manufactured in the wet-on-dry scheme, ‘S0’ may include the step for forming the positive electrode by coating and drying the positive electrode slurry on the positive electrode current collector, forming the second solid electrolyte layer by coating and drying the second solid electrolyte slurry on the positive electrode, and coating and drying the first solid electrolyte slurry on the second solid electrolyte layer.

In addition, ‘S0’ may include the steps for manufacturing the negative electrode assembly including the negative electrode and the first solid electrolyte layer (S1″), manufacturing the positive electrode assembly including the positive electrode and the second solid electrolyte layer (S2″), and stacking the positive electrode assembly and the negative electrode assembly such that the first solid electrolyte layer and the second solid electrolyte layer face each other (S3″). The negative electrode assembly or the positive electrode assembly may be manufactured in a wet-on-wet scheme or a wet-on-dry scheme.

When the negative electrode assembly or the positive electrode assembly is manufactured in the wet-on-wet scheme, ‘S0’ may include the steps for coating the negative electrode slurry on the negative electrode current collector, and sequentially coating and drying the first solid electrolyte slurry in the state that the negative electrode slurry coated on the negative electrode current collector is not dried, coating the positive electrode slurry on the positive electrode current collector, and sequentially coating and drying the second solid electrolyte slurry in the state that the positive electrode slurry coated on the positive electrode current collector is not dried.

When the negative electrode assembly or the positive electrode assembly are manufactured in the wet-on-dry scheme, ‘S0’ may include the step for forming the negative electrode by coating and drying the negative electrode slurry on the negative electrode current collector, forming the first solid electrolyte layer by coating and drying the first solid electrolyte slurry on the negative electrode, forming the positive electrode by coating and drying the positive electrode slurry on the positive electrode current collector, and forming the second solid electrolyte layer by coating and drying the second solid electrolyte slurry on the positive electrode.

The drying step in the negative electrode assembly or the positive electrode assembly may be the step for evaporating a solvent of each slurry to remain only the solid component, and may include various manners without specific limitation, as long as the drying step is to effectively remove the solvent. The drying step may be performed at the temperature preferably ranging from 60° C. to 120° C., and more preferably ranging from 70° C. to 110° C.

### EMBODIMENTS

Hereinafter, an embodiment of the present disclosure will be described in more detail. However, the following embodiment is provided only for the illustrative purpose, and the scope of the present disclosure is not limited to the following embodiment.

### Embodiment 1

(S1) The negative electrode was manufactured by coating, on the negative electrode current collector of Ni-foil, the negative electrode slurry, which was prepared by mixing 58.8 wt % of a Si-Gr composite serving as the negative electrode active material, 39.2 wt % of a sulfide-based solid electrolyte, and 2 wt % of a polybutadiene rubber serving as the binder with butyl butyrate, and drying the result structure.

(S2) The first solid electrolyte layer was formed by coating, on the negative electrode, the first solid electrolyte layer slurry obtained by mixing 30 wt % of LATP serving as the inorganic flame retardant, and 3 wt % of polybutadiene rubber serving as the binder with butyl butyrate serving as the solvent, and drying the result structure at the temperature of 90° C.

(S3) The second solid electrolyte layer was formed by coating, on the first solid electrolyte layer, the second solid electrolyte layer slurry obtained by mixing 15 wt % of Al(OH)₃ serving as the endothermic flame retardant, and 3 wt % of polybutadiene rubber serving as the binder with butyl butyrate serving as the solvent, and drying the result structure at the temperature of 90° C.

(S4) The positive electrode was formed by coating, on the positive electrode current collector of Al-foil, the positive electrode slurry, which was prepared by mixing 77.12 wt % of NCM 811 serving as the positive electrode active material, 19.28 wt % of a sulfide-based solid electrolyte, 2 wt % of a polybutadiene rubber serving as the binder, and 1.5 wt % of spherical carbon serving as the conductive material with butyl butyrate, and drying the result structure.

(S5) The positive electrode onto the second solid electrolyte layer was compressed to manufacture the all-solid-state battery.

In this case, the ratio between the thickness of the second solid electrolyte layer and the thickness of the first solid electrolyte layer was adjusted to 7:3.

### Embodiment 2

The all-solid-state battery was manufactured in a method the same as that of Embodiment 1, except that the ratio between the thickness of the second solid electrolyte layer and the thickness of the first solid electrolyte layer was adjusted to 1:1.

### Embodiment 3

The all-solid-state battery was manufactured in a method the same as that of Embodiment 1, except that the ratio between the thickness of the second solid electrolyte layer and the thickness of the first solid electrolyte layer was adjusted to 3:7.

### Comparative Example 1

The all-solid-state battery was manufactured in a method the same as that of Embodiment 1, except that the solid electrolyte layer was formed by coating the solid electrolyte slurry prepared by mixing 97 wt % of sulfide-based solid electrolyte and 3 wt % of polybutadiene with butyl butyrate and drying the result, instead of ‘S2’ and ‘S3’ of Embodiment 1.

### Comparative Example 2

The all-solid-state battery was manufactured in a method the same as that of Embodiment 1, except for forming a solid electrolyte layer by coating and drying a solid electrolyte layer slurry, which was obtained by mixing 15 wt % of Al(OH)₃ serving as the endothermic flame retardant, 30 wt % of LATP serving as the inorganic flame retardant, and 3 wt % of polybutadiene rubber serving as the binder, with butyl butyrate serving as the solvent, instead of (S2) and (S3) of Embodiment 1.

### Experimental Example 1: Analysis of Thermal Characteristic of Cell

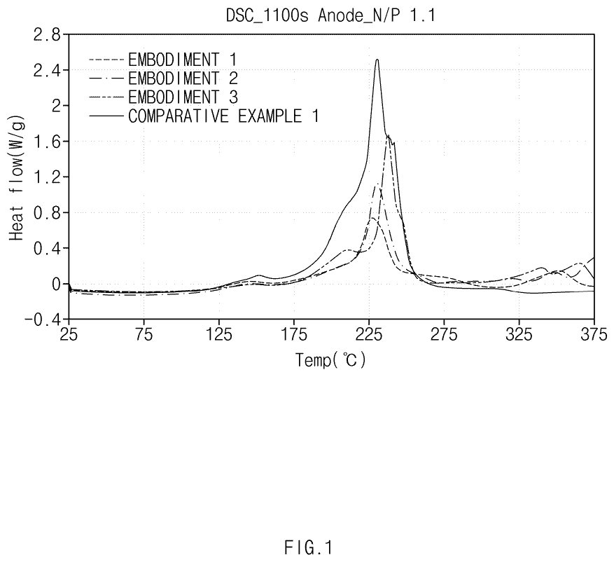

In the present experiment, after a cell manufactured in the Embodiments and the preparation examples was charged in 100% of SOC, the thermal characteristic of the cell was analyzed through Differential Scanning calorimetry (DSC). The experiment was performed at the atmosphere of Ar, and a temperature increasing rate was adjusted to 5° C./min at the temperature ranging from 25° C. to 350° C. Thereafter, the analysis results (ion conductivity [mS/cm], a heat emitting start temperature [° C.], and a calorific value [J/g]) are shown in following Table 1, and the calorific value based on the temperature is illustrated in the form of a graph as illustrated in FIG. 1.

TABLE 1

| | | Heat emitting | |
|---|---|---|---|
| | Ion conductivity | start temperature | Calorific |
| | [mS/cm] | [° C.] | value [J/g] |
| Embodiment | 1.91 | 187.4 | 897.8 |
| 1 | | | |
| Embodiment | 2.64 | 186.53 | 916.4 |
| 2 | | | |
| Embodiment | 2.57 | 180.75 | 930.5 |
| 3 | | | |
| Comparative | 3.04 | 174.66 | 993.1 |
| example 1 | | | |

Referring to Table 1 and FIG. 1, it may be recognized that Embodiment 1 showed the highest heat emitting start temperature, and the lowest calorific value to improve most greatly the thermal stability. In addition, it may be recognized that Embodiments 2 and 3 showed higher heat emitting start temperatures and lower calorific value as compared as Comparative example 1. Accordingly, it may be recognized that a cell having the double layer solid electrolyte including the endothermic flame retardant and the ceramic-based flame retardant, which is similar to the present disclosure, was more improved in thermal stability as compared to an existing cell including a solid electrolyte layer.

### Experimental Example 2: Robustness of Electrolyte Layer Determined as being Improved

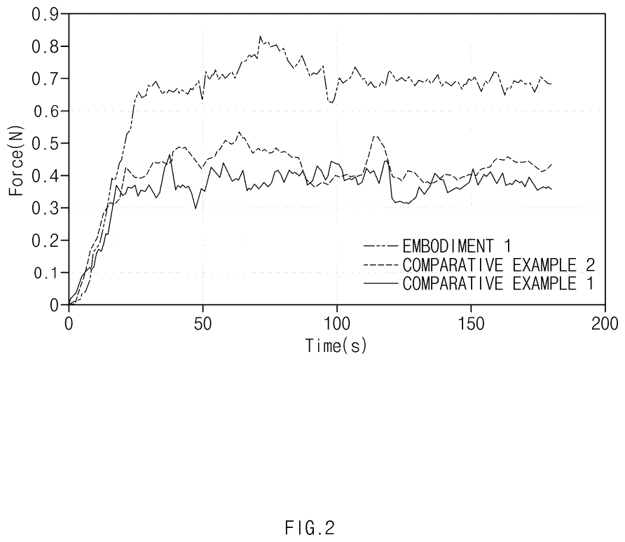

In the present experiment, the improvement degree of the robustness of electrolyte layers was determined by measuring the resistances of the electrolyte layers of the all-solid-state batteries manufactured in the Embodiments and the Comparative examples. The experiment was performed by using equipment of “Saicas” under the condition in which horizontal force was 1N, a depth was 2 μm, a rake angle was 20°, a shearing angle was 45°, and a vertical velocity was 5 μm/s, and the resistance was measured over time, which are shown in the form of a graph as illustrated in FIG. 2.

As recognized through FIG. 2, the cell according to an embodiment of the present disclosure was improved more than the comparative examples, in robustness. In other words, Comparative examples 1 and 2 including a solid electrolyte layer having a single layer structure was inferior to Embodiments in resistance, and the present disclosure exhibited a more improved robustness effect of the electrolyte layer by providing the double layer solid electrolyte including the endothermic flame retardant and the ceramic-based retardant.

### Experimental Example 3: Electro-Chemical Characteristic of Cell Determined

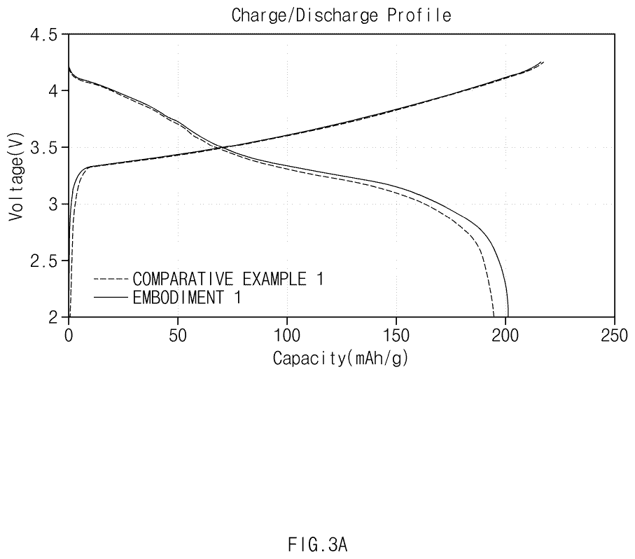

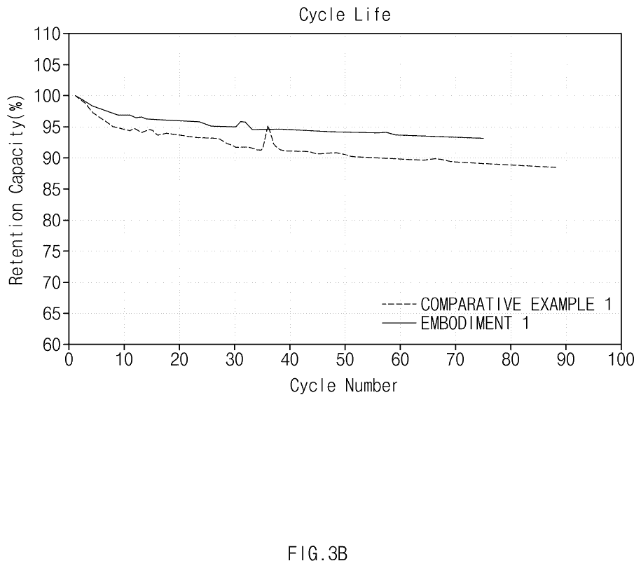

In the present experiment, the electro-chemical characteristics of all-solid-state batteries manufactured according to the embodiments and the comparative examples were evaluated. In the present experiment, the charging/discharging condition was maintained while ranging from 2.0 V to 4.25 V at the temperature of 30° C., formation was performed at 0.05 C during two cycles, and charging/discharging was performed at 0.2 C. Accordingly, a charging/discharging graph and a retention capacity (%) as a function of a cycle number are illustrated in the form of graphs as illustrated in FIGS. 3A and 3B.

As recognized through FIG. 3A, the cell according to an embodiment of the present disclosure exhibited a similar charging capacity and a higher discharging capacity as compared with the comparative example. Accordingly, it may be recognized that an embodiment of the present disclosure exhibits charging/discharging performance similar to existing performance of the comparative examples. In addition, as recognized through FIG. 3B, although the cell according to an embodiment of the present disclosure excellently maintains a capacity even if cycles are increased, a cell according to the comparative example was sharply reduced in capacity during an initial cycle, and was consecutively reduced in capacity. Accordingly, it may be recognized that an embodiment of the present disclosure exhibited stable retention capacity, as compared with the comparative examples. Accordingly, it may be recognized that the present disclosure achieves a charging/discharging characteristic and retention capacity similar to those of the existing cell by providing the double layer solid electrolyte including the endothermic flame retardant and the ceramic-based retardant.

### Experimental Example 4: Improvement of Stability of Cell Determined

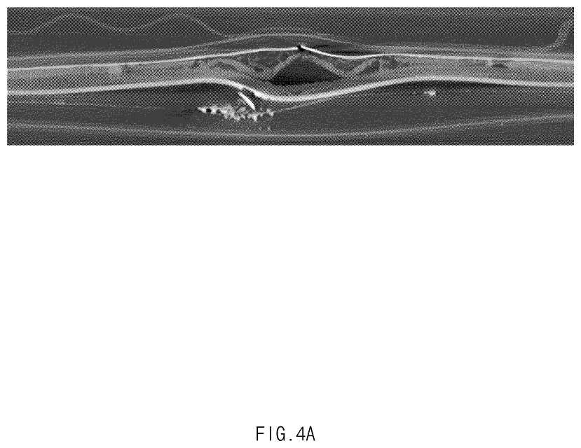

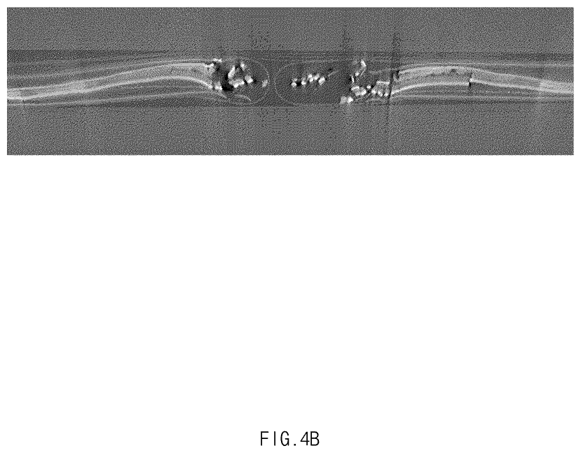

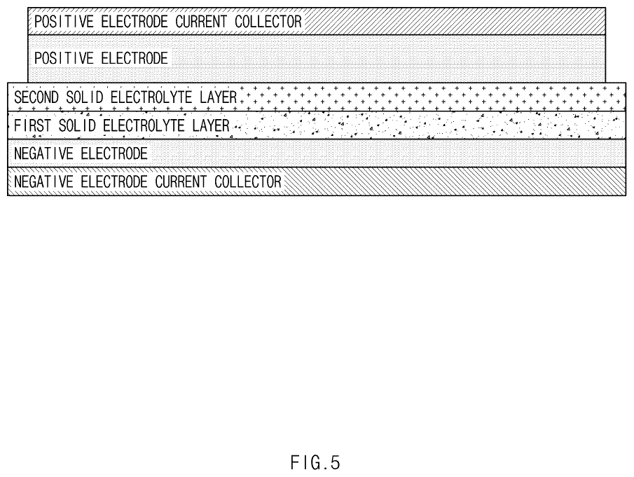

In the present experiment, an impact experiment was performed using the all-solid-state batteries manufactured according to the embodiment and the comparative examples. The present experiment was performed by freely dropping a weight, which has the diameter of 15.8 mm and the mass of 9.1 kg, to a cell having 97% of SOC from the height of 61 cm, and the cross-section of the all-solid-state battery was measured through CT analysis after the experiment. The results of the experiment are illustrated in FIGS. 4A and 4B.

As recognized through FIGS. 4A and 4B, in the all-solid-state battery according to the present disclosure, the electrolyte layer was not broken even by the external impact. However, it may be recognized that in the all-solid-state battery according to the comparative example, the cell was broken together with the solid electrolyte layer by the external impact. Accordingly, it may be recognized that the stability of the cell was improved by providing the double layer solid electrolyte including the endothermic flame retardant and the ceramic-based retardant.

The all-solid-state battery according to the present disclosure includes the double layer structure of the first solid electrolyte layer and the second solid electrolyte layer. The first solid electrolyte layer includes the inorganic flame retardant having the higher particle strength to maintain the robustness even if the negative electrode is greatly expanded in volume and precipitate the lithium metal, and the second solid electrolyte layer includes the endothermic flame retardant to improve the thermal stability in the positive electrode part. Accordingly, the all-solid-state battery may not be broken down even due to the external impact to improve stability, may exhibit a capacity retention rate higher than the existing all-solid-state battery even though cycles are repeated, and may more suppress the thermal runway phenomenon than the existing all-solid-state battery.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An all-solid-state battery comprising:
a negative electrode;
a first solid electrolyte layer positioned on the negative electrode;
a second solid electrolyte layer disposed on the first solid electrolyte layer; and
a positive electrode positioned on the second solid electrolyte layer,
wherein the first solid electrolyte layer includes an inorganic flame retardant, and
wherein the second solid electrolyte layer includes an endothermic flame retardant.

2. The all-solid-state battery of claim 1, wherein the inorganic flame retardant includes at least one selected from the group consisting of LLZO, LATP, SiO₂, ZnO, SnO₂, Mn₃O₄, Sn₂P₂O₇, an aluminum oxide, a magnesium oxide, zeolite, a zirconium compound, a calcium salt, and a boron compound.

3. The all-solid-state battery of claim 1, wherein the first solid electrolyte layer includes the inorganic flame retardant in an amount ranging from 20 wt % to 50 wt %, based on a weight of a solid electrolyte included in the first solid electrolyte layer.

4. The all-solid-state battery of claim 1, wherein the endothermic flame retardant includes at least one selected from the group consisting of Mg(OH)₂, Al(OH)₃, Sb₂O₃, H₃BO₃, Fe(OH)₃, CaCO₃, Ca(OH)₂, Zn(OH)₂, NaOH, a calcium-magnesium hydroxide, hydrotalcite, bemate, talc, doconite, calcium sulfate hydrate, and magnesium sulfate hydrate.

5. The all-solid-state battery of claim 1, wherein the second solid electrolyte layer includes the endothermic flame retardant in an amount ranging from 5 wt % to 20 wt %, based on a weight of a solid electrolyte included in the second solid electrolyte layer.

6. The all-solid-state battery of claim 1, wherein a ratio between a thickness of the first solid electrolyte layer and a thickness of the second solid electrolyte layer ranges from 1:9 to 9:1.

7. The all-solid-state battery of claim 1, wherein a sum of a thickness of the first solid electrolyte layer and a thickness of the second solid electrolyte layer ranges from 10 μm to 120 μm.

8. The all-solid-state battery of claim 1, wherein each of the first solid electrolyte layer and the second solid electrolyte layer further includes a binder.

9. The all-solid-state battery of claim 8, wherein the content of the binder ranges from 0.5 wt % to 5 wt %, based on a weight of a solid electrolyte in each of the first solid electrolyte layer and the second solid electrolyte layer.

10. The all-solid-state battery of claim 8, wherein the binder includes at least one selected from the group consisting of polybutadiene rubber (BR), styrene-butadiene rubber (SBR), nitrile butadiene rubber (NBR), polyimide (PI), polyvinylidene fluoride (PVDF), and ethylene propylene diene monomer rubber (EPDM).

11. A method for manufacturing an all-solid-state battery, the method comprising:
manufacturing the all-solid-state battery in which a negative electrode, a first solid electrolyte layer, a second solid electrolyte layer, and a positive electrode are sequentially stacked (S0),
wherein the first solid electrolyte layer includes an inorganic flame retardant, and
wherein the second solid electrolyte layer includes an endothermic flame retardant.

12. The method of claim 11, wherein the manufacturing the all-solid-state battery include:
manufacturing a negative electrode assembly by sequentially stacking the negative electrode, the first solid electrolyte layer, and the second solid electrolyte layer; and
stacking the negative electrode assembly and the positive electrode such that the second solid electrolyte layer faces the positive electrode.

13. The method of claim 12, wherein the negative electrode assembly is manufactured in a wet-on-wet or wet-on-dry scheme.

14. The method of claim 11, wherein the manufacturing the all-solid-state battery includes:
manufacturing a positive electrode assembly by sequentially stacking the positive electrode, the second solid electrolyte layer, and the first solid electrolyte layer; and
stacking the positive electrode assembly and the negative electrode such that the first solid electrolyte layer faces the negative electrode.

15. The method of claim 14, wherein the positive electrode assembly is manufactured in a wet-on-wet or wet-on-dry scheme.

16. The method of claim 11, wherein the manufacturing the all-solid-state battery includes:
manufacturing a negative electrode assembly including the negative electrode and the first solid electrolyte layer;
manufacturing a positive electrode assembly including the positive electrode and the second solid electrolyte layer; and
stacking the positive electrode assembly and the positive electrode assembly such that the first solid electrolyte layer and the second solid electrolyte layer face each other.

17. The method of claim 16, wherein each of the negative electrode assembly or the positive electrode assembly is manufactured in a wet-on-wet or wet-on-dry scheme.

18. An all-solid-state battery comprising:
a negative electrode;
a first solid electrolyte layer positioned on the negative electrode;
a second solid electrolyte layer disposed on the first solid electrolyte layer; and
a positive electrode positioned on the second solid electrolyte layer,
wherein the first solid electrolyte layer includes at least one component selected from the group consisting of LLZO, LATP, SiO₂, ZnO, SnO₂, Mn₃O₄, Sn₂P₂O₇, an aluminum oxide, a magnesium oxide, zeolite, a zirconium compound, a calcium salt, and a boron compound, and
wherein the second solid electrolyte layer includes at least one component selected from the group consisting of Mg(OH)₂, Al(OH)₃, Sb₂O₃, H₃BO₃, Fe(OH)₃, CaCO₃, Ca(OH)₂, Zn(OH)₂, NaOH, a calcium-magnesium hydroxide, hydrotalcite, bemate, talc, doconite, calcium sulfate hydrate, and magnesium sulfate hydrate.

19. The all-solid-state battery of claim 18, wherein the at least one component included in the first solid electrolyte layer is in an amount ranging from 20 wt % to 50 wt %, based on a weight of a solid electrolyte included in the first solid electrolyte layer.

20. The all-solid-state battery of claim 18, wherein the at least one component included in the second solid electrolyte layer is in an amount ranging from 5 wt % to 20 wt %, based on a weight of a solid electrolyte included in the second solid electrolyte layer.
